(19) United States
(12) Patent Application Publication
(10) Pub. No.: US 2026/0237250 A1
(43) Pub. Date: Aug. 13, 2026

(54) ANOMALY PREDICTION SYSTEM, ANOMALY PREDICTION DEVICE, CLASSIFICATION GENERATION DEVICE, ANOMALY PREDICTION METHOD, AND NON-TRANSITORY COMPUTER-READABLE MEDIUM STORING ANOMALY PREDICTION PROGRAM

(71) Applicant: NEC Corporation, Tokyo (JP)

(72) Inventor: Takahiro KATO, Tokyo (JP)

(73) Assignee: NEC Corporation, Tokyo (JP)

(21) Appl. No.: 19/149,201

(22) PCT Filed: Mar. 20, 2023
(86) PCT No.: PCT/JP2023/010813

§ 371 Date: Jul. 18, 2025

(51) Int. Cl. G07C 5/08; G07C 5/00

(52) U.S. Cl. CPC G07C 5/0808; G07C 5/008; G07C 5/0841

(57) ABSTRACT

In the present invention, an abnormality prediction system comprises: a road information database that stores road information in which road position information and road classification in which roads are classified in accordance with the effect on the internal abnormality of a vehicle are associated with each other; and an abnormality prediction device that can communicate with the road information database. The abnormality prediction device: acquires a travel road history of a designated vehicle, for which internal abnormality is to be predicted; acquires the road information from the road information database for a road included in the travel road history; and predicts the internal abnormality of the designated vehicle on the basis of the road information for the road included in the travel road history of the designated vehicle.

### TECHNICAL FIELD

The present disclosure relates to an anomaly prediction system, an anomaly prediction device, a classification generation device, an anomaly prediction method, and a non-transitory computer-readable medium storing an anomaly prediction program.

### BACKGROUND ART

In recent years, it has been required to predict a failure part of a vehicle in advance from the viewpoint of improving the convenience of an owner of the vehicle and reducing a work burden on a repair shop such as a sales shop. There has been known that in a case where a vehicle travels on a road under a specific condition, a specific component tends to fail. Therefore, it is considered that the failure part can be predicted based on a traveling road history of the vehicle.

For example, PTL 1 discloses a technique of classifying a region where a vehicle travels into a plurality of areas according to geographic information, setting the ease of wearing of each component for each area, and predicting a component having a high possibility of failure in the vehicle.

### CITATION LIST

### Patent Literature

PTL 1: JP 2004-234375 A

### SUMMARY OF INVENTION

### Technical Problem

Even in a case of a road having similar geographic information, components which are likely to break down in vehicles passing through the respective roads may be different depending on individual road conditions or the like. Therefore, there is room for further improving the prediction accuracy of the failed component.

The present disclosure has been made to solve such a problem, and an object thereof is to provide an anomaly prediction system, an anomaly prediction device, a classification generation device, an anomaly prediction method, and a non-transitory computer-readable medium storing an anomaly prediction program, which are capable of accurately predicting an internal anomaly.

### Solution to Problem

An anomaly prediction system according to the present disclosure includes
a road information database that stores road information in which position information about a road is associated with a road classification into which the road is classified according to an influence on an internal anomaly of a vehicle, and
an anomaly prediction device capable of communicating with the road information database, in which
the anomaly prediction device
acquires a traveling road history of a target vehicle for which an internal anomaly is to be predicted,
acquires the road information from the road information database for a road included in the traveling road history, and
predicts an internal anomaly of the target vehicle based on the road information about the road included in the traveling road history of the target vehicle.

An anomaly prediction device according to the present disclosure includes
a traveling road history acquisition unit for acquiring a traveling road history of a target vehicle for which an internal anomaly is to be predicted,
a road information acquisition unit for acquiring road information about the road included in the traveling road history from a predetermined road information database that stores the road information in which position information about the road is associated with a road classification into which the road is classified according to an influence on an internal anomaly of the vehicle, and
a prediction for predicting the internal anomaly of the target vehicle based on the road information about the road included in the traveling road history of the target vehicle.

A classification generation device according to the present disclosure includes
a vehicle data acquisition unit for acquiring vehicle data in which traveling road histories of a plurality of vehicles are associated with a vehicle state of each of the plurality of vehicles at the time of traveling on a road,
a geographic information acquisition unit for acquiring geographic information about the road included in the vehicle data from a predetermined map information database, and
a classification generation unit for generating a road classification according to an influence on an internal anomaly of the vehicle based on the vehicle data and the geographic information, and registering the road classification in a road information database.

An anomaly prediction method according to the present disclosure, for causing a computer to
acquire a traveling road history of a target vehicle for which an internal anomaly is to be predicted,
acquire road information about the road included in the traveling road history from a predetermined road information database that stores the road information in which position information about the road is associated with a road classification into which the road is classified according to an influence on an internal anomaly of the vehicle, and
predict the internal anomaly of the target vehicle based on the road information about the road included in the traveling road history of the target vehicle.

A non-transitory computer-readable medium storing an anomaly prediction program according to the present disclosure, for causing a computer to execute processing of
acquiring a traveling road history of a target vehicle for which an internal anomaly is to be predicted,
acquiring the road information about the road included in the traveling road history from a predetermined road information database that stores road information in which position information about the road is associated with a road classification into which the road is classified according to an influence on the internal anomaly of the vehicle, and
predicting an internal anomaly of the target vehicle based on the road information about the road included in the traveling road history of the target vehicle.

### Advantageous Effects of Invention

According to the present disclosure, it is possible to provide an anomaly prediction device, system, method, and a non-transitory computer-readable medium storing a program, which are capable of accurately predicting an internal anomaly.

### BRIEF DESCRIPTION OF DRAWINGS

FIG. 1 is a block diagram illustrating a configuration of an anomaly prediction system according to a first example embodiment.

FIG. 2 is a flowchart illustrating a flow of an anomaly prediction method according to the first example embodiment.

FIG. 3 is a block diagram illustrating a configuration of an anomaly prediction system according to a second example embodiment.

FIG. 4 is a block diagram illustrating a configuration of a classification generation device according to the second example embodiment.

FIG. 5 is a flowchart illustrating a flow of classification generation processing according to the second example embodiment.

FIG. 6 is a block diagram illustrating a configuration of an anomaly prediction device according to the second example embodiment.

FIG. 7 is a flowchart illustrating a flow of anomaly prediction processing according to the second example embodiment.

FIG. 8 is a block diagram illustrating a configuration of an anomaly prediction system according to a third example embodiment.

FIG. 9 is a block diagram illustrating a configuration of a classification generation device according to the third example embodiment.

FIG. 10 is a flowchart illustrating a flow of influence information generation processing in the third example embodiment.

FIG. 11 is a flowchart illustrating a flow of anomaly prediction processing according to the third example embodiment.

FIG. 12 is a block diagram illustrating a configuration of an anomaly prediction device according to a fourth example embodiment.

FIG. 13 is a flowchart illustrating a flow of anomaly prediction processing according to the fourth example embodiment.

### EXAMPLE EMBODIMENT

Hereinafter, example embodiments of the present disclosure will be described in detail with reference to the drawings. In the drawings, the same or corresponding elements are denoted by the same reference numerals, and redundant description is omitted as necessary for clarity of description.

### First Example Embodiment

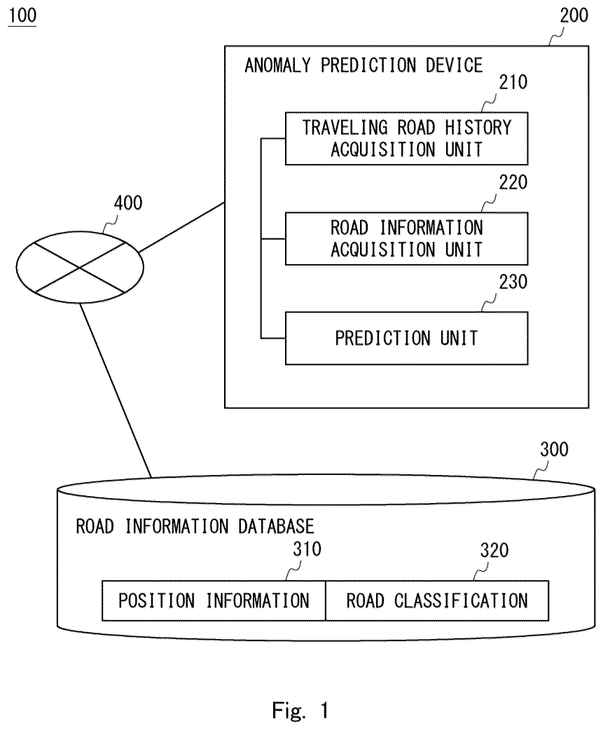

FIG. 1 is a block diagram illustrating a configuration of an anomaly prediction system 100 according to a first example embodiment. The anomaly prediction system 100 includes an anomaly prediction device 200 and a road information database 300. The anomaly prediction device 200 and the road information database 300 are connected to a network 400. Therefore, the anomaly prediction device 200 can communicate with the road information database 300 via the network 400. The network 400 may be a wired communication line or a wireless communication line. The network 400 may include the Internet.

The road information database 300 stores road information in which a road classification 320 is associated with position information 310. The position information 310 is information indicating a position of a road. The road classification 320 classifies roads according to an influence on an internal anomaly of a vehicle. The internal anomaly of the vehicle is, for example, a failure of a component included in the vehicle. The road information database 300 stores road information about a plurality of roads.

The anomaly prediction device 200 is a device that predicts an internal anomaly of the vehicle. The anomaly prediction device 200 is, for example, a device that can be operated by an employee of a repair shop that repairs a vehicle, such as a vehicle shop. Hereinafter, a vehicle for which an internal anomaly is predicted may be referred to as a target vehicle. The anomaly prediction device 200 includes a traveling road history acquisition unit 210, a road information acquisition unit 220, and a prediction unit 230. The traveling road history acquisition unit 210 acquires a traveling road history of the target vehicle for which the internal anomaly is to be predicted. The traveling road history includes a history of a road on which the vehicle has traveled. The road information acquisition unit 220 acquires road information from the road information database 300 for the road included in a traveling road history acquired by the traveling road history acquisition unit 210. The prediction unit 230 predicts an internal anomaly of the target vehicle based on the road information acquired by the road information acquisition unit 220.

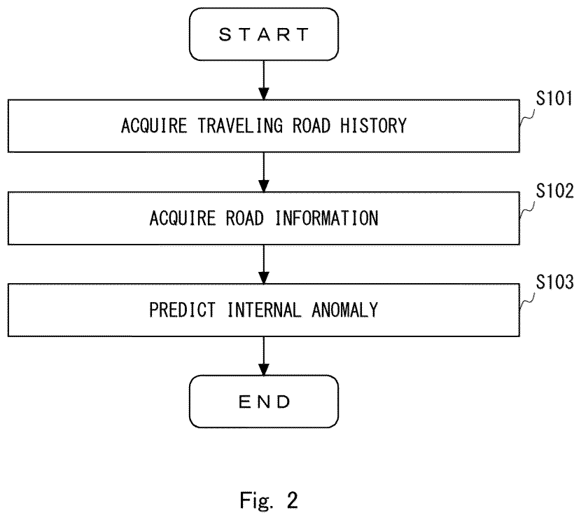

FIG. 2 is a flowchart illustrating a flow of an anomaly prediction method according to the first example embodiment. First, the traveling road history acquisition unit 210 acquires the traveling road history of the target vehicle for which an internal anomaly is to be predicted (step S101). Next, the road information acquisition unit 220 acquires road information from the road information database 300 for the road included in the traveling road history acquired in step S101 (step S102). Next, the prediction unit 230 predicts the internal anomaly of the target vehicle based on the road information acquired in step S102 (step S103). As described above, the anomaly prediction method according to the first example embodiment predicts the internal anomaly of the target vehicle based on the road classification classified according to the influence on the internal anomaly of the vehicle. Therefore, it is possible to accurately predict a part where the anomaly occurs.

The anomaly prediction device 200 includes a processor, a memory, and a storage device as a configuration (not illustrated). The storage device stores a computer program in which the processing of the anomaly prediction method according to the first example embodiment is implemented. Then, the processor reads the computer program from the storage device into the memory and executes the computer program. As a result, the processor achieves functions as the traveling road history acquisition unit 210, the road information acquisition unit 220, and the prediction unit 230.

Each of the traveling road history acquisition unit 210, the road information acquisition unit 220, and the prediction unit 230 may be achieved by dedicated hardware. Some or all of the components of each device may be implemented by a general-purpose or dedicated circuitry, a processor, or a combination thereof. These components may be configured with a single chip or may be configured with a plurality of chips connected via a bus. Some or all of the components of each device may be achieved by a combination of the above-described circuitry or the like and a program. As the processor, a central processing unit (CPU), a graphics processing unit (GPU), a field-programmable gate array (FPGA), or the like can be used.

In a case where some or all of the components of the anomaly prediction device 200 are achieved by a plurality of information processing devices, circuitry, and the like, the plurality of information processing devices, circuitry, and the like may be arranged in a centralized manner or in a distributed manner. For example, the information processing devices, the circuitry, or the like may be implemented in the form of a client server system, a cloud computing system, or the like in which they are connected to each other through a communication network. The function of the anomaly prediction device 200 may be provided in a software as a service (Saas) format.

### Second Example Embodiment

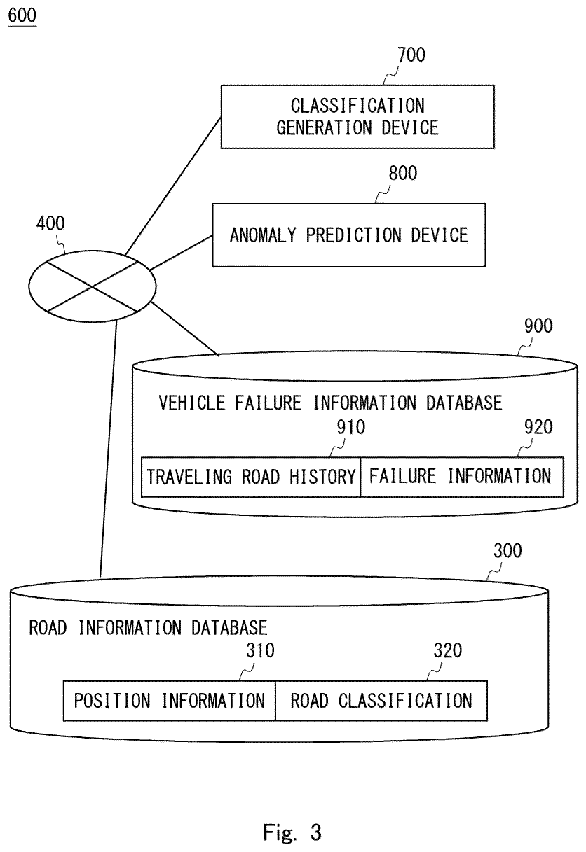

A second example embodiment is a specific example of the above-described first example embodiment. FIG. 3 is a block diagram illustrating a configuration of an anomaly prediction system 600 according to the second example embodiment. The anomaly prediction system 600 includes a classification generation device 700, an anomaly prediction device 800, a vehicle failure information database 900, and a road information database 300. The classification generation device 700, the anomaly prediction device 800, the vehicle failure information database 900, and the road information database 300 are communicably connected via a network 400. Hereinafter, description overlapping with the first example embodiment will be appropriately omitted.

The anomaly prediction system 600 is an information system for predicting an internal anomaly of a target vehicle in which an owner notifies a repair shop that an anomaly has occurred. The target vehicle is, for example, an automobile, but may be a vehicle other than an automobile such as a motorcycle or an electric kickboard. The vehicle failure information database 900 stores vehicle failure information in which the failure information 920 is associated with the traveling road history 910. The failure information 920 is information including a failure part of the vehicle. The failure part of the vehicle is, for example, a component configuring the vehicle such as a brake, a gear box, an engine, a battery, or a tire. The failure information 920 may include information about a failure mode. A mode of the failure is, for example, a state of breakage, a degree of wear or tear. The vehicle failure information database 900 stores vehicle failure information about a plurality of vehicles.

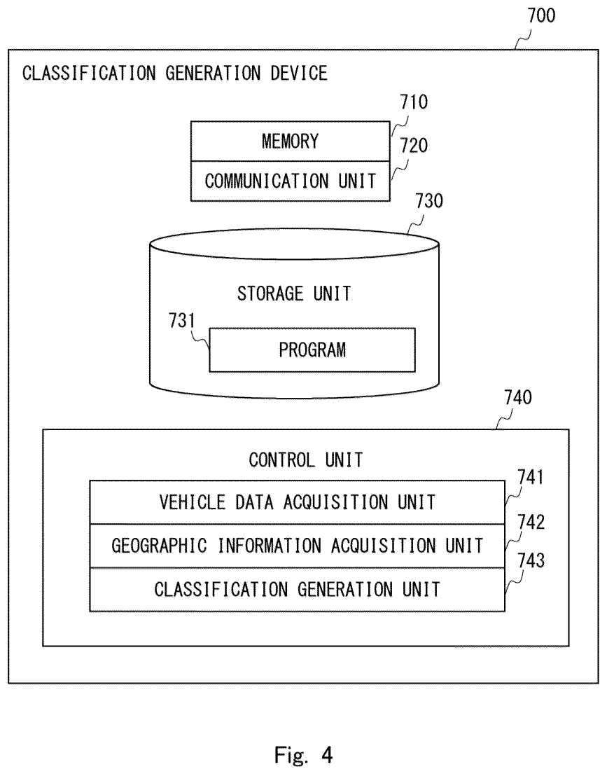

Next, a configuration of the classification generation device 700 will be described in detail with reference to FIG. 4. FIG. 4 is a block diagram illustrating a configuration of the classification generation device 700. The classification generation device 700 includes a memory 710, a communication unit 720, a storage unit 730, and a control unit 740.

The memory 710 is a storage area for temporarily storing processing contents of the control unit 740, and is, for example, a volatile storage device such as a random access memory (RAM). The communication unit 720 is an interface that communicates with an outside of the classification generation device 700. The storage unit 730 is a storage device that stores the program 731 and the like. The program 731 is a computer program in which the classification generation processing according to the second example embodiment is implemented.

The control unit 740 includes a vehicle data acquisition unit 741, a geographic information acquisition unit 742, and a classification generation unit 743. The control unit 740 is a control device that controls the operation of the classification generation device 700, and is, for example, a processor such as a CPU. The control unit 740 reads the program 731 from the storage unit 730 into the memory 710 and executes the program. As a result, the control unit 740 achieves functions as the vehicle data acquisition unit 741, the geographic information acquisition unit 742, and the classification generation unit 743.

The vehicle data acquisition unit 741 acquires vehicle data of a plurality of vehicles. The vehicle data is data in which a vehicle state at the time of traveling on the road is associated with a traveling road history of the vehicle. The vehicle state is a state of the vehicle related to driving, and is, for example, acceleration/deceleration and steering of the vehicle. The vehicle data is, for example, data obtained by collecting a state of a connected car at the time of traveling by various sensors or the like. In this case, the plurality of vehicles from which the vehicle data acquisition unit 741 acquires the vehicle data are connected cars.

The geographic information acquisition unit 742 acquires geographic information about a road included in the vehicle data acquired by the vehicle data acquisition unit 741 from a predetermined map information database. The predetermined map information database is an existing map information database, and is, for example, a geographic information system (GIS, Geographic Information System) of the Geospatial Information Authority of Japan. The geographic information is information about the geography of a road, and includes positional information about the road and information about geographic conditions. The geographical condition is a condition related to geography such as topography, climate, and soil, and is specifically, for example, a condition of being a road along the sea, a mountain road, and a road in an urban area.

The classification generation unit 743 generates a road classification based on the vehicle data acquired by the vehicle data acquisition unit 741 and the geographic information acquired by the geographic information acquisition unit 742, and registers the generated road classification in the road information database 300. Specifically, for example, the classification generation unit 743 compares the vehicle data with the geographic information to identify a combination of the geographic information about the road on which the vehicle has traveled and the state of the vehicle at the time of traveling on the road.

Depending on the state of the vehicle at the time of traveling on the road and geographic information about the road, components that are likely to fail in the vehicle may change, that is, the influence on the internal anomaly of the vehicle may change. Therefore, the classification generation unit 743 generates a road classification according to a combination of geographic information about the road on which the vehicle has traveled and a state of the vehicle at the time of traveling on the road, and registers the generated road classification in the road information database 300 in association with the road.

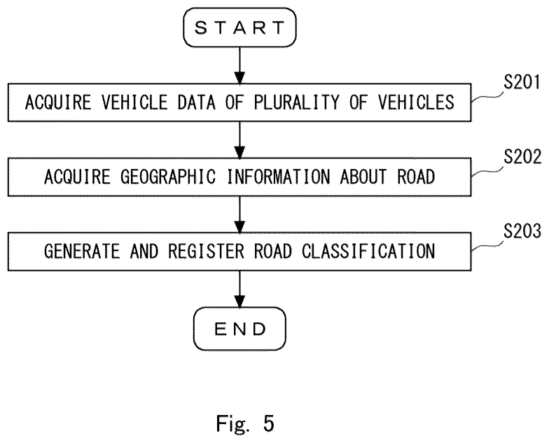

Next, an operation of the classification generation device 700 at the time of classification generation will be described with reference to FIG. 5. FIG. 5 is a flowchart illustrating a flow of classification generation processing.

First, the vehicle data acquisition unit 741 acquires vehicle data of a plurality of vehicles (step S201). Next, the geographic information acquisition unit 742 extracts a road on which each vehicle has traveled from the traveling road history included in the vehicle data acquired in step S201, and acquires geographic information about the road from a predetermined map information database (step S202). Next, the classification generation unit 743 generates a road classification based on the vehicle data acquired in step S201 and the geographic information acquired in step S202, and registers the generated road classification in the road information database 300 (step S203). As described above, the classification generation device 700 according to the second example embodiment generates road classifications classified according to the influence on the internal anomaly of the vehicle, and registers the road classifications in the road information database 300.

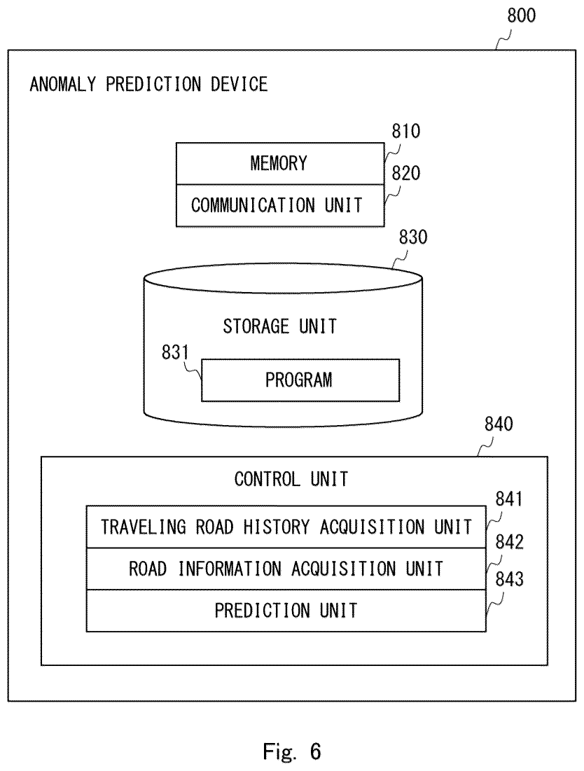

Next, a configuration of the anomaly prediction device 800 will be described in detail with reference to FIG. 6. FIG. 6 is a block diagram illustrating a configuration of the anomaly prediction device 800. The anomaly prediction device 800 includes a memory 810, a communication unit 820, a storage unit 830, and a control unit 840.

The memory 810 is a storage region for temporarily storing processing contents of the control unit 840, and is, for example, a volatile storage device such as a random access memory (RAM). The communication unit 820 is an interface that communicates with the outside of the anomaly prediction device 800. The storage unit 830 is a storage device that stores a program 831 and the like. The program 831 is a computer program in which the anomaly prediction processing according to the second example embodiment is implemented.

The control unit 840 includes a traveling road history acquisition unit 841, a road information acquisition unit 842, and a prediction unit 843. The control unit 840 is a control device that controls the operation of the anomaly prediction device 800, and is, for example, a processor such as a CPU. The control unit 840 reads the program 831 from the storage unit 830 into the memory 810 and executes the program. As a result, the control unit 840 achieves functions as the traveling road history acquisition unit 841, the road information acquisition unit 842, and the prediction unit 843.

The anomaly prediction device 800 is a device that can be operated by an employee of a repair shop that repairs a vehicle, such as a vehicle shop, and includes, for example, an input device for an employee to perform various inputs, a display device that displays a prediction result of an internal anomaly, and the like as hardware (not illustrated). In a case where a malfunction occurs in the vehicle, an owner of the vehicle notifies the repair shop of the malfunction. Upon receiving the notification from the owner, the employee of the repair shop inputs to the anomaly prediction device 800 that the internal anomaly is predicted for the vehicle, that is, the target vehicle.

In a case where the fact that the internal anomaly is predicted for the target vehicle is input to the anomaly prediction device 800, the traveling road history acquisition unit 841 acquires the traveling road history of the target vehicle. The traveling road history of the target vehicle includes a history of a road on which the target vehicle has traveled. The traveling road history of the target vehicle is, for example, a record of a global positioning system (GPS) provided in the target vehicle. The traveling road history acquisition unit 841 can acquire the traveling road history of the target vehicle by acquiring the GPS record of the target vehicle. The traveling road history acquisition unit 841 acquires the traveling road histories of the plurality of vehicles from the vehicle failure information database 900.

The road information acquisition unit 842 acquires road information from the road information database 300 for the road included in the traveling road history of the target vehicle acquired by the traveling road history acquisition unit 841. The road information acquisition unit 842 acquires road information from the road information database 300 for roads included in the traveling road histories of a plurality of vehicles acquired by the traveling road history acquisition unit 841.

The prediction unit 843 predicts the internal anomaly of the target vehicle based on the traveling road history of the target vehicle acquired by the traveling road history acquisition unit 841 and the road information acquired by the road information acquisition unit 842. Specifically, first, the prediction unit 843 compares the road classification of the road included in the traveling road history of the target vehicle with the road classification of the road included in the traveling road history of the plurality of vehicles. There is usually a plurality of roads included in the traveling road history. Different road classifications may be associated with each road included in the traveling road history. Hereinafter, a set of road classifications associated with each road included in the traveling road history may be referred to as a breakdown of the road classifications. The prediction unit 843 compares the breakdown of the road classification of the target vehicle with the breakdown of the road classifications of the plurality of vehicles, and identifies a similar vehicle having a similar breakdown of the road classification similar to that of the target vehicle from among the plurality of vehicles whose breakdown information is registered in the vehicle failure information database 900. Since the similar vehicle has a similar road classification breakdown to that of the target vehicle, it is estimated that there is a high possibility that the similar vehicle has an internal anomaly similar to that of the target vehicle. Therefore, the prediction unit 843 acquires failure information about a similar vehicle from the vehicle failure information database 900 and predicts an internal anomaly of the target vehicle.

A comparison method in a case where the prediction unit 843 compares the breakdown of the road categories is not particularly limited, and can be appropriately set. For example, the prediction unit 843 may weight each road classification according to a travel distance on each road included in the traveling road history and compare the target vehicle with a plurality of vehicles.

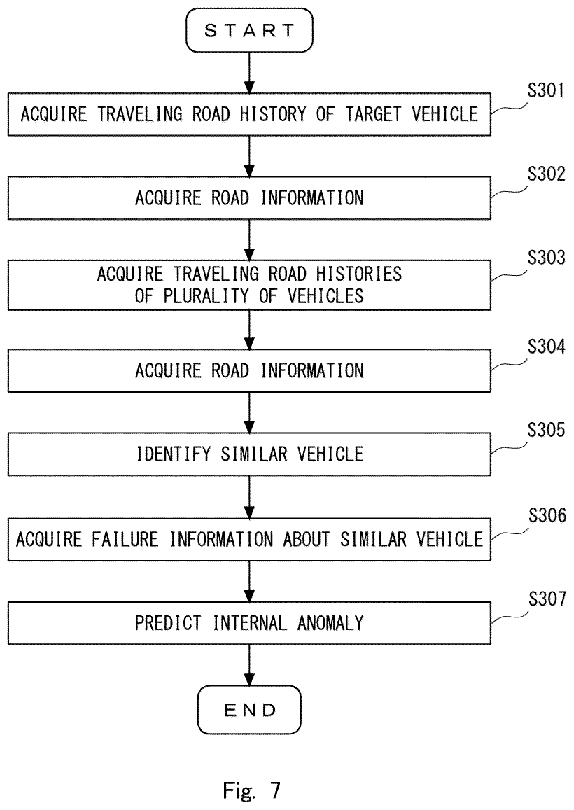

Next, the operation of the anomaly prediction device 800 at the time of anomaly prediction will be described with reference to FIG. 7. FIG. 7 is a flowchart illustrating a flow of anomaly prediction processing.

In a case where the anomaly prediction device 800 is input with a fact that the internal anomaly is predicted for the target vehicle by the operation of the employee, the traveling road history acquisition unit 841 acquires the traveling road history of the target vehicle (step S301). Next, the road information acquisition unit 842 extracts a road on which the target vehicle has traveled from the traveling road history of the target vehicle acquired in step S301, and acquires road information about the road from the road information database 300 (step S302). Next, the traveling road history acquisition unit 841 acquires the traveling road histories of the plurality of vehicles from the vehicle failure information database 900 (step S303). Next, the road information acquisition unit 842 extracts a road on which each vehicle has traveled from the traveling road histories of the plurality of vehicles acquired in step S303, and acquires road information about the road from the road information database 300 (step S304). In the example illustrated in FIG. 7, a case where steps S303 and S304 are performed after steps S301 and S302 has been described. However, steps S303 and S304 may be performed before steps S301 and S302, or may be performed in parallel with steps S301 and S302.

Next, the prediction unit 843 compares the road information acquired in step S302 with the road information acquired in step S304, and identifies a similar vehicle similar to the target vehicle from among the plurality of vehicles (step S305). Next, the prediction unit 843 acquires failure information about the similar vehicle identified in step S305 from the vehicle failure information database 900 (step S306). Next, the prediction unit 843 predicts the internal anomaly of the target vehicle based on the failure information acquired in step S306 (step S307).

The anomaly prediction device 800 outputs the prediction result predicted in step S307 to a display device or the like. An employee of the repair shop can check the displayed prediction result, and based on the prediction result, order a component that is likely to be required for repairing the target vehicle from a manufacturer or the like before the owner visits. Therefore, in a case where an owner visits a repair shop together with the target vehicle, an employee can identify an anomaly part and repair the anomaly part on the same day.

As described above, since the anomaly prediction device 800 according to the second example embodiment identifies a similar vehicle having a road classification similar to that of the target vehicle and predicts the internal anomaly of the target vehicle based on the failure information about the similar vehicle, it is possible to accurately predict the part where the anomaly has occurred. Since the anomaly prediction device 800 predicts the internal anomaly using the GPS record of the target vehicle, it is possible to predict the internal anomaly even if the vehicle is not provided with various sensors such as a connected car.

### Third Example Embodiment

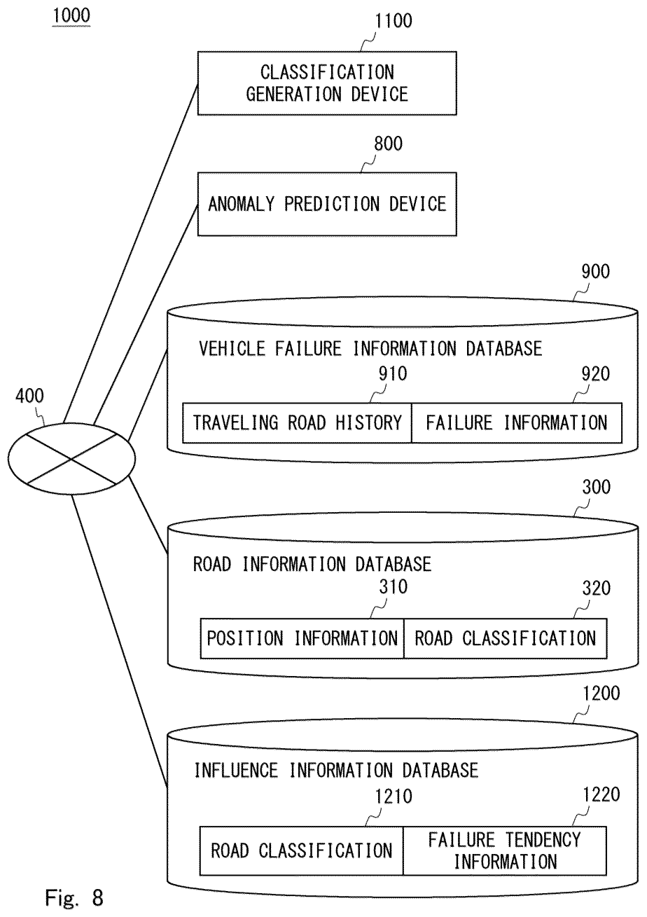

A third example embodiment is a modified example of the second example embodiment described above. In the third example embodiment, an internal anomaly in a target vehicle is predicted based on influence information associated with a road classification. FIG. 8 is a block diagram illustrating a configuration of an anomaly prediction system 1000 according to the third example embodiment. The anomaly prediction system 1000 is different from the anomaly prediction system 600 illustrated in FIG. 3 in including a classification generation device 1100 instead of the classification generation device 700 and further including an influence information database 1200. Since other configurations overlap with those of the second example embodiment and the like, the description thereof will be omitted as appropriate.

The influence information database 1200 stores influence information in which the failure tendency information 1220 is associated with the road classification 1210. The failure tendency information 1220 is information indicating a tendency of a failure that is likely to occur in a vehicle traveling on a road associated with a road classification. The failure tendency information 1220 includes a tendency of a failure part of the vehicle. The failure part of the vehicle is, for example, a component configuring the vehicle such as a brake, a gear box, an engine, a battery, or a tire. The failure tendency information 1220 may include information about a tendency of a failure mode. A mode of the failure is, for example, a state of breakage, a degree of wear or tear. The influence information database 1200 stores influence information about a plurality of road classifications.

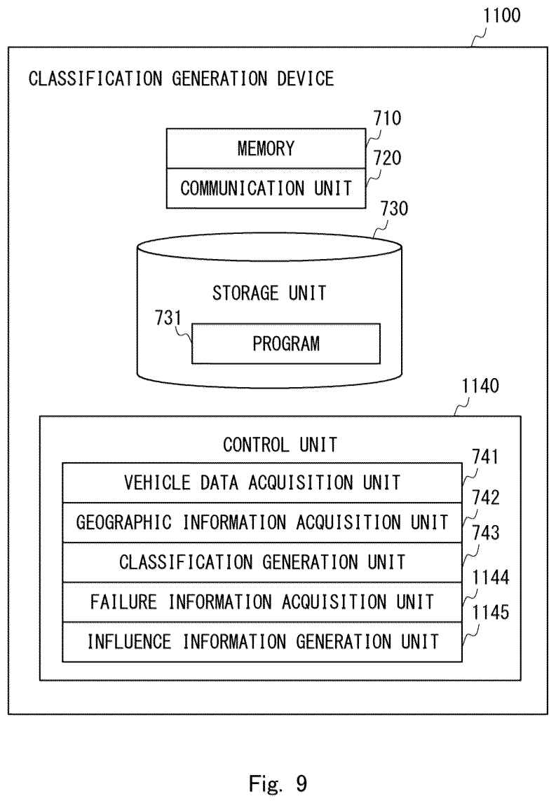

Next, a configuration of the classification generation device 1100 will be described in detail with reference to FIG. 9. FIG. 9 is a block diagram illustrating a configuration of the classification generation device 1100. The classification generation device 1100 is different from the classification generation device 700 illustrated in FIG. 4 in that a control unit 1140 is provided instead of the control unit 740. The control unit 1140 includes a failure information acquisition unit 1144 and an influence information generation unit 1145 in addition to the configuration illustrated in the control unit 740.

The failure information acquisition unit 1144 acquires failure information about a plurality of vehicles from the vehicle failure information database 900. The influence information generation unit 1145 generates influence information based on the traveling road history included in the vehicle data acquired by the vehicle data acquisition unit 741 and the failure information acquired by the failure information acquisition unit 1144, and registers the generated influence information in the influence information database 1200. The influence information generation unit 1145 may generate failure tendency information included in the influence information by performing statistical processing on the failure information about the plurality of vehicles. For example, in a case where the failure information about the plurality of vehicles includes the degree of wear of the brake, the influence information generation unit 1145 may calculate a representative value from the degree of wear of the plurality of brakes and use the calculated representative value as the degree of wear of the brake in the failure tendency information. The representative value may be an average value, a mode value, a median value, a maximum value, a minimum value, or the like. The influence information generation unit 1145 generates influence information by associating a road classification associated with a road included in a traveling road history with failure tendency information indicating a tendency of a failure that is likely to occur in a vehicle traveling on the road.

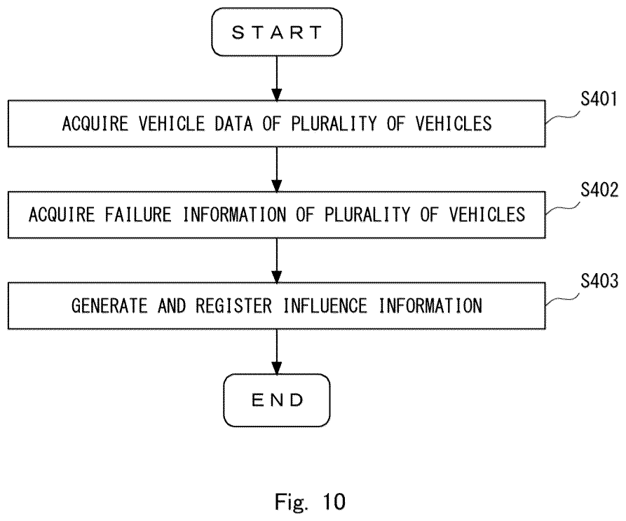

Next, the operation of the classification generation device 1100 at the time of generating influence information will be described with reference to FIG. 10. FIG. 10 is a flowchart illustrating a flow of influence information generation processing.

First, the vehicle data acquisition unit 741 acquires vehicle data of a plurality of vehicles (step S401). Next, the failure information acquisition unit 1144 acquires failure information about a plurality of vehicles from the vehicle failure information database 900 (step S402). Next, the influence information generation unit 1145 generates influence information based on the vehicle data acquired in step S401 and the failure information acquired in step S402, and registers the generated influence information in the influence information database 1200 (step S403).

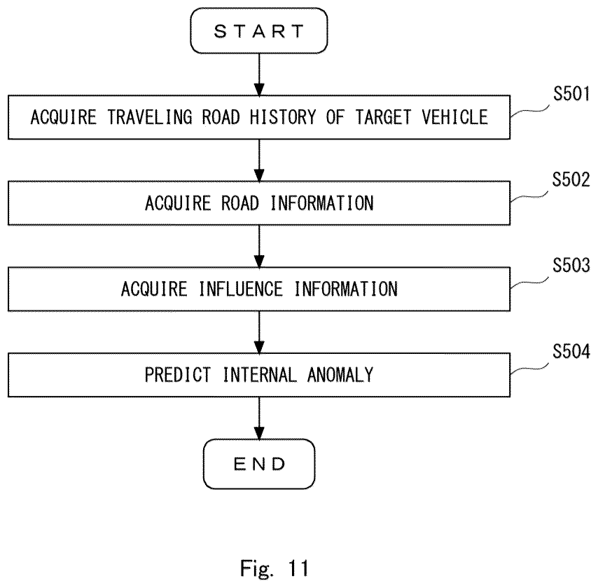

Next, the operation of the anomaly prediction device 800 according to the third example embodiment will be described with reference to FIG. 11. FIG. 11 is a flowchart illustrating a flow of anomaly prediction processing.

In a case where the anomaly prediction device 800 is input with a fact that the internal anomaly is predicted for the target vehicle by the operation of the employee, the traveling road history acquisition unit 841 acquires the traveling road history of the target vehicle (step S501). Next, the road information acquisition unit 842 extracts a road on which the target vehicle has traveled from the traveling road history of the target vehicle acquired in step S501, and acquires road information about the road from the road information database 300 (step S502). Next, the prediction unit 843 acquires influence information associated with a road classification included in the road information acquired in step S502 from the influence information database 1200 (step S503). Next, the prediction unit 843 predicts the internal anomaly of the target vehicle based on the influence information acquired in step S503 (step S504).

As described above, since the anomaly prediction system 1000 according to the third example embodiment predicts the internal anomaly of the target vehicle based on the influence information in which the failure tendency information is associated with the road classification, the anomaly prediction device 800 can accurately predict the part where the anomaly has occurred without referring to the vehicle failure information database 900.

### Fourth Example Embodiment

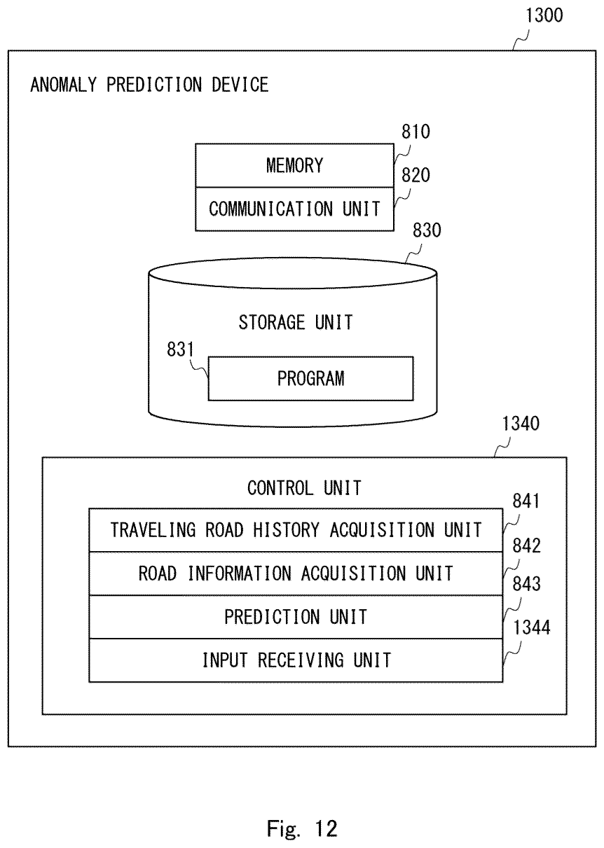

A fourth example embodiment is a modified example of the second example embodiment described above. In the fourth example embodiment, the internal anomaly is predicted using interview information obtained from an owner. FIG. 12 is a block diagram illustrating a configuration of an anomaly prediction device 1300 according to the fourth example embodiment. The anomaly prediction device 1300 is different from the anomaly prediction device 800 illustrated in FIG. 6 in that a control unit 1340 is provided instead of the control unit 840. The control unit 1340 includes an input receiving unit 1344 in addition to the configuration included in the control unit 840.

The input receiving unit 1344 receives contents input by an employee operating an input device or the like. In a case where an employee receives a notification from an owner of a vehicle that a malfunction has occurred in the vehicle, the employee asks the owner about malfunction information. The malfunction information is information including specific contents of a malfunction of the vehicle, and is, for example, “abnormal noise occurs at the time of braking”. The employee inputs the contents of the interview, that is, the interview information including the malfunction information about the vehicle to an input device or the like. The input receiving unit 1344 receives an input of the interview information.

In the fourth example embodiment, the prediction unit 843 predicts the internal anomaly of the target vehicle based on the interview information input by the input receiving unit 1344, the traveling road history of the target vehicle acquired by the traveling road history acquisition unit 841, and the road information acquired by the road information acquisition unit 842. Specifically, first, the prediction unit 843 narrows down a part where there is a high possibility that an internal anomaly has occurred based on the interview information. Specifically, for example, in a case where the interview information is “abnormal noise occurs during braking”, the prediction unit 843 determines that there is a high possibility that an internal anomaly has occurred in the brake and its peripheral members. Next, the prediction unit 843 compares the road classification of the road included in the traveling road history of the target vehicle with the road classification of the road included in the traveling road history of the plurality of vehicles, and identifies a similar vehicle similar to the target vehicle. Next, the prediction unit 843 acquires failure information about a similar vehicle from the vehicle failure information database 900, and predicts an internal anomaly for a part where there is a high possibility that an internal anomaly has occurred, the part being narrowed down based on the interview information.

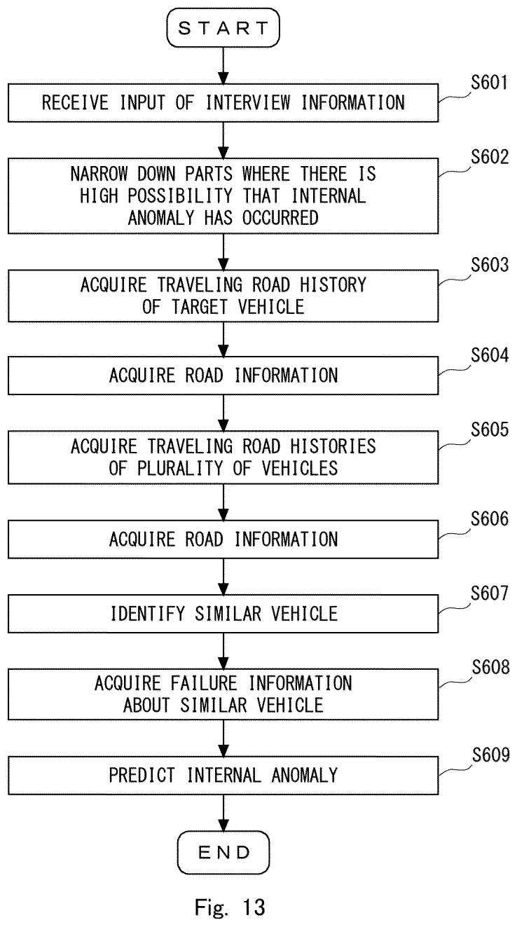

Next, the operation of the anomaly prediction device 1300 at the time of anomaly prediction will be described with reference to FIG. 13. FIG. 13 is a flowchart illustrating a flow of anomaly prediction processing.

In a case where the inquiry information about the target vehicle is input to the anomaly prediction device 800 by the operation of the employee, the input receiving unit 1344 receives the input of the interview information (step S601). Next, the prediction unit 843 narrows down parts where there is a high possibility that the internal anomaly has occurred based on the interview information input in step S601 (step S602).

Next, the traveling road history acquisition unit 841 acquires the traveling road history of the target vehicle (step S603). Next, the road information acquisition unit 842 extracts a road on which the target vehicle has traveled from the traveling road history of the target vehicle acquired in step S603, and acquires road information about the road from the road information database 300 (step S604). Next, the traveling road history acquisition unit 841 acquires the traveling road histories of the plurality of vehicles from the vehicle failure information database 900 (step S605). Next, the road information acquisition unit 842 extracts a road on which each vehicle has traveled from the traveling road histories of the plurality of vehicles acquired in step S605, and acquires road information about the road from the road information database 300 (step S606).

Next, the prediction unit 843 compares the road information acquired in step S604 with the road information acquired in step S606, and identifies a similar vehicle similar to the target vehicle from among the plurality of vehicles (Step S607). Next, the prediction unit 843 acquires failure information about the similar vehicle identified in step S607 from the vehicle failure information database 900 (step S608). Next, based on the failure information acquired in step S607, the prediction unit 843 predicts an internal anomaly of the target vehicle at the part narrowed down in step S602 (step S609).

As described above, the anomaly prediction device 1300 according to the fourth example embodiment predicts the internal anomaly after narrowing down the parts where the internal anomaly is likely to occur based on the interview information. Therefore, the part where the anomaly occurs can be predicted more accurately.

In the above-described example embodiments, the configuration of the hardware has been described, but the present disclosure is not limited thereto. According to the present disclosure, any processing can also be implemented by causing a CPU to execute a computer program.

In the above-described example, the program can be stored in various types of non-transitory computer-readable media and supplied to a computer. The non-transitory computer-readable media include various types of tangible storage media. Examples of the non-transitory computer-readable media include a magnetic recording medium (e.g., a flexible disk, a magnetic tape, or a hard disk drive), a magneto-optical recording medium (e.g., a magneto-optical disc), a CD-read only memory (ROM), a CD-R, a CD-R/W, a digital versatile disc (DVD), and a semiconductor memory (e.g., a mask ROM, a programmable ROM (PROM), an erasable PROM (EPROM), a flash ROM, or a random access memory (RAM)). The program may be supplied to the computer by various types of transitory computer-readable media. Examples of transitory computer-readable media include electrical signals, optical signals, and electromagnetic waves. The transitory computer-readable media can supply the programs to the computer via wired or wireless communication paths such as wires and optical fiber.

The present disclosure is not limited to the above example embodiments, and can be appropriately changed without departing from the scope. The present disclosure may be implemented by appropriately combining the example embodiments.

Some or all of the above example embodiments may be described as the following Supplementary Notes, but are not limited to the following.

### Supplementary Note A1

An anomaly prediction system including:
a road information database that stores road information in which position information about a road is associated with a road classification into which the road is classified according to an influence on an internal anomaly of a vehicle; and
an anomaly prediction device capable of communicating with the road information database,
in which the anomaly prediction device
acquires a traveling road history of a target vehicle for which an internal anomaly is to be predicted,
acquires the road information from the road information database for a road included in the traveling road history, and
predicts an internal anomaly of the target vehicle based on the road information about the road included in the traveling road history of the target vehicle.

### Supplementary Note A2

The anomaly prediction system according to Supplementary Note A1, further including a vehicle failure information database that is communicable with the anomaly prediction device and stores vehicle failure information in which traveling road histories of a plurality of vehicles are associated with failure information about each of the plurality of vehicles,
in which the anomaly prediction device
identifies a similar vehicle having a similar traveling road history to that of the target vehicle from among the plurality of vehicles based on the traveling road history of the target vehicle and the road information, and predicts the internal anomaly of the target vehicle based on the failure information about the similar vehicle.

### Supplementary Note A3

The anomaly prediction system according to Supplementary Note A1, further including a classification generation device capable of communicating with the road information database,
in which the classification generation device
acquires vehicle data in which the traveling road histories of the plurality of vehicles are associated with a vehicle state of each of the plurality of vehicles during traveling on the road,
acquires geographic information about the road included in the vehicle data from a predetermined map information database, and
generates the road classification based on the vehicle data and the geographic information, and registers the road classification in the road information database.

### Supplementary Note A4

The anomaly prediction system according to Supplementary Note A3, further including an influence information database that is communicable with the anomaly prediction device and the classification generation device and stores influence information in which the road classification is associated with failure tendency information indicating a tendency of a failure that is likely to occur in a vehicle that has traveled on the road, in which
the classification generation device
acquires the failure information about the plurality of vehicles,
generates the influence information in which the road classification associated with the road included in the traveling road history is associated with failure tendency information indicating the tendency of the failure that is likely to occur in the vehicle that has traveled on the road based on the traveling road history and the failure information about the plurality of vehicles, and registers the influence information in the road information database, and
the anomaly prediction device
acquires the road classification associated with the road included in the traveling road history of the target vehicle, and predicts the internal anomaly of the target vehicle based on the influence information associated with the road classification.

### Supplementary Note A5

The anomaly prediction system according to Supplementary Note A1, in which the anomaly prediction device
receives an input of interview information including malfunction information about the vehicle, and
predicts the internal anomaly of the vehicle based on the interview information, the traveling road history, and the road information.

### Supplementary Note B1

An anomaly prediction device including:
traveling road history acquisition means for acquiring a traveling road history of a target vehicle for which an internal anomaly is to be predicted;
road information acquisition means for acquiring road information about the road included in the traveling road history from a predetermined road information database that stores the road information in which position information about the road is associated with a road classification into which the road is classified according to an influence on an internal anomaly of the vehicle; and
prediction means for predicting the internal anomaly of the target vehicle based on the road information about the road included in the traveling road history of the target vehicle.

### Supplementary Note B2

The anomaly prediction device according to Supplementary Note B1, in which the prediction means identifies a similar vehicle having a similar traveling road history to that of the target vehicle from among a plurality of vehicles based on the traveling road history of the target vehicle and the road information, and predicts the internal anomaly of the target vehicle based on failure information about the similar vehicle acquired from a predetermined vehicle failure information database that stores vehicle failure information in which the traveling road histories of the plurality of vehicles are associated with the failure information about each of the plurality of vehicles.

### Supplementary Note C1

A classification generation device including:
vehicle data acquisition means for acquiring vehicle data in which traveling road histories of a plurality of vehicles are associated with a vehicle state of each of the plurality of vehicles during traveling on a road;
geographic information acquisition means for acquiring geographic information about the road included in the vehicle data from a predetermined map information database; and
classification generation means for generating a road classification into which the road is classified according to an influence on an internal anomaly of the vehicle based on the vehicle data and the geographic information, and registering the road classification in a road information database.

### Supplementary Note C2

The classification generation device according to Supplementary Note C1, further including:
failure information acquisition means for acquiring failure information about the plurality of vehicles; and
influence information generation means for generating influence information in which the road classification associated with the road included in the traveling road history is associated with failure tendency information indicating a tendency of a failure that is likely to occur in the vehicle that has traveled on the road based on the traveling road history and the failure information about the plurality of vehicles, and registering the influence information in the road information database.

### Supplementary Note D1

An anomaly prediction method for causing a computer to:
acquire a traveling road history of a target vehicle for which an internal anomaly is to be predicted;
acquire road information about the road included in the traveling road history from a predetermined road information database that stores the road information in which position information about the road is associated with a road classification into which the road is classified according to an influence on an internal anomaly of the vehicle; and
predict the internal anomaly of the target vehicle based on the road information about the road included in the traveling road history of the target vehicle.

### Supplementary Note E1

A non-transitory computer-readable medium storing an anomaly prediction program for causing a computer to execute processing of:

acquiring a traveling road history of a target vehicle for which an internal anomaly is to be predicted;

acquiring the road information about the road included in the traveling road history from a predetermined road information database that stores road information in which position information about the road is associated with a road classification into which the road is classified according to an influence on the internal anomaly of the vehicle; and
predicting an internal anomaly of the target vehicle based on the road information about the road included in the traveling road history of the target vehicle.

While the present invention has been particularly shown and described with reference to the example embodiments (and examples) thereof, the present invention is not limited to these example embodiments (and examples). It will be understood by those of ordinary skill in the art that various changes in form and details may be made therein without departing from the spirit and scope of the present invention as defined by the claims.

### REFERENCE SIGNS LIST

100 anomaly prediction system
200 anomaly prediction device
210 traveling road history acquisition unit
220 road information acquisition unit
230 prediction unit
300 road information database
310 position information
320 road classification
400 network
600 anomaly prediction system
700 classification generation device
710 memory
720 communication unit
730 storage unit
731 program
740 control unit
741 vehicle data acquisition unit
743 classification generation unit
800 anomaly prediction device
810 memory
820 communication unit
830 storage unit
831 program
840 control unit
841 traveling road history acquisition unit
842 road information acquisition unit
843 prediction unit
900 vehicle failure information database
910 traveling road history
920 failure information
1000 anomaly prediction system
1100 classification generation device
1140 control unit
1144 failure information acquisition unit
1145 influence information generation unit
1200 influence information database
1210 road classification
1220 failure tendency information
1300 anomaly prediction device
1340 control unit
1344 input receiving unit

What is claimed is:

1. An anomaly prediction system comprising:
a road information database that stores road information in which position information about a road is associated with a road classification into which the road is classified according to an influence on an internal anomaly of a vehicle; and
an anomaly prediction device capable of communicating with the road information database, wherein
the anomaly prediction device comprising:
at least one memory storing instructions, and
at least one processor configured to execute the instructions to;
acquire a traveling road history of a target vehicle for which an internal anomaly is to be predicted,
acquire the road information from the road information database for a road included in the traveling road history, and
predict an internal anomaly of the target vehicle based on the road information about the road included in the traveling road history of the target vehicle.

2. The anomaly prediction system according to claim 1, further comprising a vehicle failure information database that is communicable with the anomaly prediction device and stores vehicle failure information in which traveling road histories of a plurality of vehicles are associated with failure information about each of the plurality of vehicles,
wherein the at least one processor of the anomaly prediction device is further configured to execute the instructions to
identify a similar vehicle having a similar traveling road history to that of the target vehicle from among the plurality of vehicles based on the traveling road history of the target vehicle and the road information, and predicts the internal anomaly of the target vehicle based on the failure information about the similar vehicle.

3. The anomaly prediction system according to claim 1, further comprising a classification generation device capable of communicating with the road information database, wherein
the classification generation device comprising:
at least one memory storing instructions, and
at least one processor configured to execute the instructions to;
acquire vehicle data in which the traveling road histories of the plurality of vehicles are associated with a vehicle state of each of the plurality of vehicles during traveling on the road,
acquire geographic information about the road included in the vehicle data from a predetermined map information database, and
generate the road classification based on the vehicle data and the geographic information, and registers the road classification in the road information database.

4. The anomaly prediction system according to claim 3, further comprising an influence information database that is communicable with the anomaly prediction device and the classification generation device and stores influence information in which the road classification is associated with failure tendency information indicating a tendency of a failure that is likely to occur in a vehicle that has traveled on the road, wherein
the at least one processor of the classification generation device is further configured to execute the instructions to
acquire the failure information about the plurality of vehicles,
generate the influence information in which the road classification associated with the road included in the traveling road history is associated with failure tendency information indicating the tendency of the failure that is likely to occur in the vehicle that has traveled on the road based on the traveling road history and the failure information about the plurality of vehicles, and registers the influence information in the road information database, and
the at least one processor of the anomaly prediction device is further configured to execute the instructions to
acquire the road classification associated with the road included in the traveling road history of the target vehicle, and predicts the internal anomaly of the target vehicle based on the influence information associated with the road classification.

5. The anomaly prediction system according to claim 1, wherein
the at least one processor of the anomaly prediction device is further configured to execute the instructions to
receive an input of interview information including malfunction information about the vehicle, and
predict the internal anomaly of the vehicle based on the interview information, the traveling road history, and the road information.

6. An anomaly prediction device comprising:
at least one memory storing instructions, and
at least one processor configured to execute the instructions to;
acquire a traveling road history of a target vehicle for which an internal anomaly is to be predicted;
acquire road information about the road included in the traveling road history from a predetermined road information database that stores the road information in which position information about the road is associated with a road classification into which the road is classified according to an influence on an internal anomaly of the vehicle; and
predict the internal anomaly of the target vehicle based on the road information about the road included in the traveling road history of the target vehicle.

7. The anomaly prediction device according to claim 6, wherein the at least one processor is further configured to execute the instructions to identify a similar vehicle having a similar traveling road history to that of the target vehicle from among a plurality of vehicles based on the traveling road history of the target vehicle and the road information, and predicts the internal anomaly of the target vehicle based on failure information about the similar vehicle acquired from a predetermined vehicle failure information database that stores vehicle failure information in which the traveling road histories of the plurality of vehicles are associated with the failure information about each of the plurality of vehicles.

8.-cm 9. (canceled)

10. An anomaly prediction method for causing a computer to:
acquire a traveling road history of a target vehicle to which an internal anomaly is to be predicted;
acquire road information about the road included in the traveling road history from a predetermined road information database that stores the road information in which position information about the road is associated with a road classification into which the road is classified according to an influence on an internal anomaly of the vehicle; and
predict the internal anomaly of the target vehicle based on the road information about the road included in the traveling road history of the target vehicle.

11. (Canceled)
